(19) United States
(12) Patent Application Publication
(10) Pub. No.: US 2012/0298708 A1
(43) Pub. Date: Nov. 29, 2012

(54) CUP HOLDER-MOUNTED CRADLE FOR ELECTRONIC DEVICES

(76) Inventor: Michael J. DeAngelo, Palm Springs, CA (US)

(21) Appl. No.: 13/480,372

(22) Filed: May 24, 2012

Related U.S. Application Data
(60) Provisional application No. 61/490,022, filed on May 25, 2011.

(51) Int. Cl. B60R 11/00

(52) U.S. Cl. 224/567

(57) ABSTRACT

An apparatus for supporting a computing device in a vehicle using a platform and cup holder receptacle or center console edge or compartment using gravity, pressure, rotational motion or additional lip to secure the apparatus is disclosed.

### CROSS-REFERENCE TO RELATED APPLICATIONS

The present application claims the benefit of and priority to U.S. Provisional Application Ser. No. 61/490,022, titled “CUP HOLDER MOUNTED CRADLE FOR ELECTRONIC DEVICE”, FILED May 25, 2011, which is hereby incorporated by reference herein in its entirety for all purposes.

### FIELD

The present disclosure generally relates to support systems for computing devices in vehicles.

There exists a need to provide vehicle manufacturers and owners with a better way to conveniently use their mobile or portable computing devices in their vehicles when such means is not already available.

### BACKGROUND

In an automobile or, any moving vehicle, users of portable or mobile computer devices may need a firm and accessible surface upon which to place those devices. As the proliferation of tablets, large format smart phones, and ultra light notebook computers has only occurred in recent years, most automobiles do not have such a surface or accommodation.

In some cases, a permanent construction may be obstructive to the use of other controls on the automobile's dashboard, or obstruct visibility, or clamps may be overly complicated, difficult to secure, or too costly.

The present disclosure makes use of the existing accommodation of cup holders or center console openings, compartments, edges, or lips, to provide a stable platform for smart phone and tablet computers by using the cup holder or center console as the feminine receptacle for a male pedestal inserted with gravity, pressure, or rotational motion, or edge with attached angled platform.

### SUMMARY

The preferred embodiments have utility in; the area of support platforms for vehicles for mobile computing devices.

The present disclosure makes use of the existing accommodation of cup holders or center console openings, compartments, edges, or lips, to provide a stable platform for smart phones and tablet computers by using the Cup holder as the feminine receptacle for a male pedestal inserted with gravity, pressure, or rotational motion, or for a platform with attached angled lip inserted or attached a center console

### BRIEF DESCRIPTION OF THE FIGURES

FIG. 1 depicts a side view of the apparatus utilizing a cup holder and including a male pedestal and platform.

FIG. 2 depicts a front view configurable cut and rolled plastic sheet accomplishing one possible construction.

FIG. 3 depicts a male pedestal into female pedestal secured by pressure or motion.

FIG. 4 depicts a side view of center console attachment with optional extra lip to prevent motion of computing device.

### DETAILED DESCRIPTION

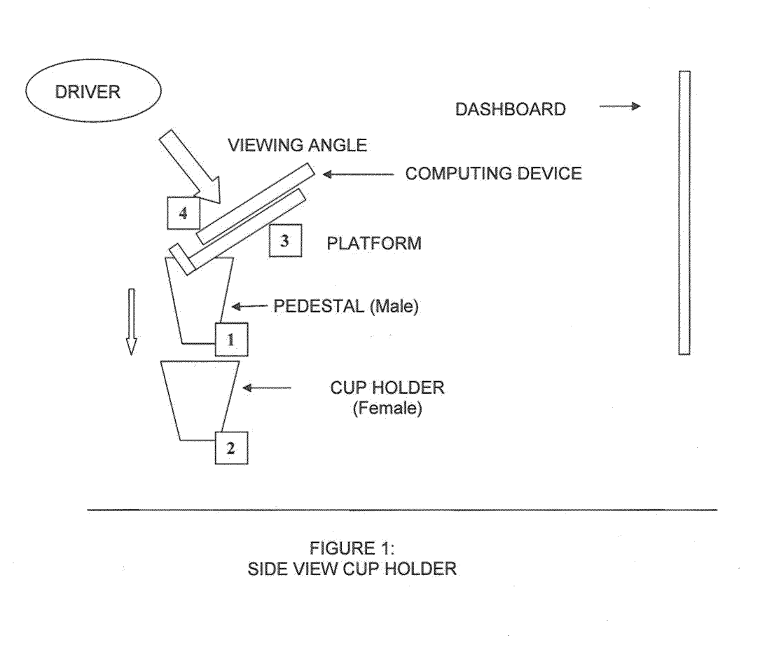

Referring now to FIG. 1, in one embodiment, the force of gravity secures a male wedge-shaped pedestal [1] into a female cup holder [2] where there need not be a resting base for the pedestal. In this embodiment, the male pedestal may be weighted sufficiently to stabilize the whole platform [3] with the smart phone or tablet sized computing device [4].

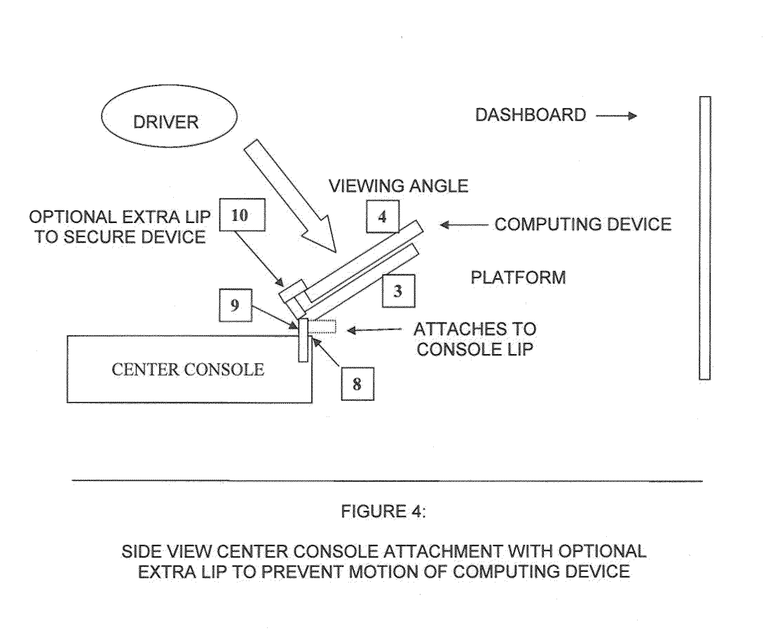

Referring now to FIG. 4, this apparatus may also be inserted, secured, or attached to any center console edge or opening [8]. The platform may also be secured to a console lip or edge [8] by an additional angled component [9]. The platform itself may also include additional edges, planes or lips [10] controlling or securing the computing device from unwanted motion or sliding.

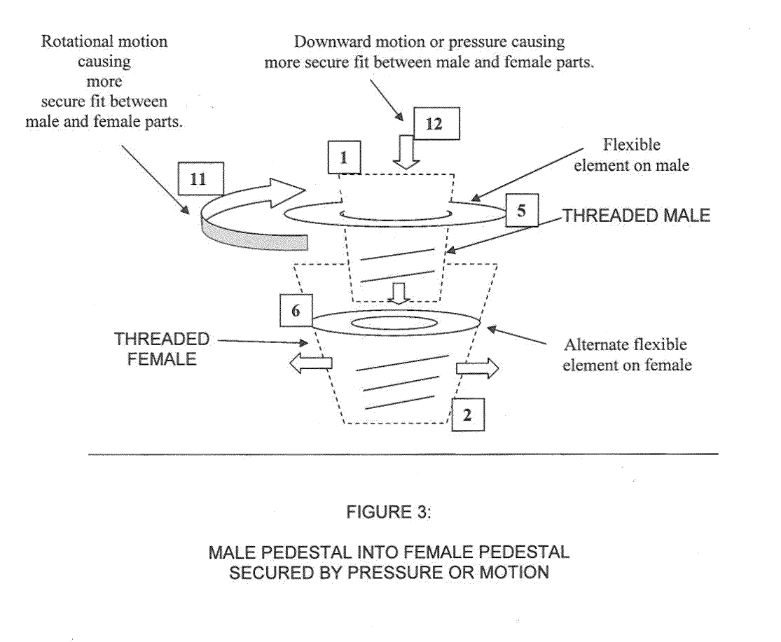

Referring now to FIG. 3, a component or mechanism may be used with pressure or motion to expand the male pedestal element to fit more securely into the female receptacle in a console. Pressure [12] on a [5] flexible element surrounding the male pedestal [1] or residing temporarily or permanently [6] in the female receptacle [2] may cause a more secure fit between the male and female components, or may force the walls of the male pedestal outward and against the female receptacle, or a rotational motion [11] may cause a threaded or threadlike interaction [6]between the male and female components.

In the present embodiment, the configuration involves a detachable unit, but future implementations may use a more integrated design, whether permanent or semi-permanent.

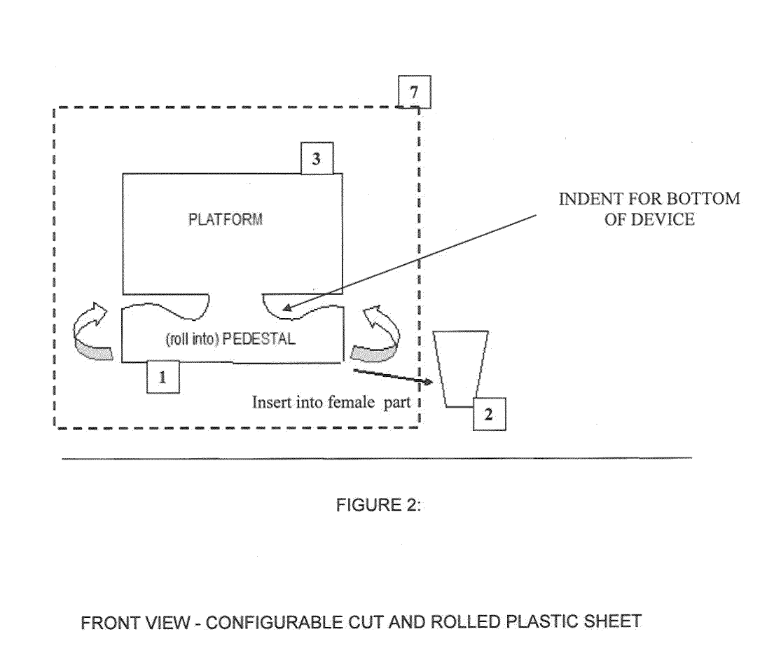

Also, Referring now to FIG. 2, in one implementation, the invention may be cut and folded, rolled or shaped from a single sheet of plastic or other material [7].

In other embodiments, other constructions may be used to achieve a similar configuration.

While the invention is susceptible to various modifications, and alternative forms, specific examples thereof have been shown in the drawings and are herein described in detail. It should be understood, however, that the invention is not to be limited to the particular forms or methods disclosed, but to the contrary; the invention is to cover all modifications, equivalents and alternatives falling within the spirit and scope of the appended claims.

What is claimed is:

1. The use of a cup holder or center console as part of any configuration to support any computing device, smart phone, or computer tablet.

2. The method of claim 1, when the cup holder is not occupied by a cup.

3. The method of claim 1, when any part of that configuration is detachable.

4. The method of claim 1, when there is any platform or back upon which the computing device can rest.

5. The method of claim 1, when there is used one sheet of plastic appropriately cut and formed

6. The method of claim 1, when there is used any pedestal to insert as a male into the female of the cup holder as a receptacle.

7. The method of claim 1, when additional edges are added to a platform in order to prevent any movement of the computing device.

8. The method of claim 1, when additional edges are added to a platform to secure the platform into the center console

9. The use of a center console in any moving vehicle as part of any configuration without a clamp to support any computing device.

10. The method of claim 9, when any part of that configuration is detachable.

11. On a platform intended to support a computing device, the use of any motion or pressure to better secure a male part into a female part

12. The method of claim 11, when the pressure causes a more secure fit by compressing or expanding a flexible element on the male part.

13. The method of claim 10, when the pressure causes a more secure fit by compressing or expanding a flexible element on the female part.

14. The method of claim 10, when the motion is rotational and causes a more secure fit by utilizing any threads or thread-like elements in the female or male part.
